(19) United States
(12) Patent Application Publication
(10) Pub. No.: US 2024/0217410 A1
(43) Pub. Date: Jul. 4, 2024

(54) METHOD FOR ATTACHING TRIM TO A SEAT CUSHION AND TRIM-COVERED SEAT CUSHION

(71) Applicant: Lear Corporation, Southfield, MI (US)

(72) Inventors: Yujie DU, Shanghai (CN); Yufeng FENG, Shanghai (CN); Peng CHENG, Shanghai (CN); Qian XIANG, Shanghai (CN); Baolong SHANG, Shanghai (CN)

(73) Assignee: Lear Corporation, Southfield, MI (US)

(21) Appl. No.: 18/521,552

(22) Filed: Nov. 28, 2023

(30) Foreign Application Priority Data
Dec. 30, 2022 (CN) 202211723035.9

(51) Int. Cl. B60N 2/58

(52) U.S. Cl. CPC B60N 2/5891; B60N 2/5875

(57) ABSTRACT

A method for attaching a trim cover to a seat cushion includes a step of attaching an adhesive web to a vehicle seat trim cover to form an adhesive-trim cover combination. A foam cushion is placed in a trim-attachment apparatus. The trim-attachment apparatus includes a heating section having a plurality of hollow injection needles and a pressing section. Each hollow injection needle defines at least one outlet opening proximate to a needle tip. The foam cushion is placed on the heating section such that the injection needles extend from the B-side of the foam cushion to the A-side of the foam cushion with the outlet opening protruding a predetermined distance from the A-side. The adhesive-trim cover combination is placed over the foam cushion. The adhesive web is heated by flowing steam or hot air through the hollow injection needles and pressed onto the foam cushion.

### CROSS-REFERENCE TO RELATED APPLICATIONS

This application claims foreign priority benefits under 35 U.S.C. § 119(a)-(d) to CN application Ser. No. 202211723035.9, filed Dec. 30, 2022, which is incorporated by reference in its entirety.

### TECHNICAL FIELD

In at least one aspect, the present invention is related to methods and equipment for attaching a trim cover to a foam cushion.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A, 1B, and 1C. Schematic flowchart of a method for attaching a trim cover to a cushion component.

FIG. 2. Schematic showing pattering of hollow needles for flowing hot gas or steam for melting adhesive web.

FIG. 3. Side view of a hollow needle.

FIG. 4. Cross-sectional view of a trim-covered foam cushion.

FIG. 5. Schematic of an apparatus for attaching a trim cover to a seat cushion.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

The terms “A-surface” and “B-surface” when referring to a seat cushion provide a physical relation to a foam seat cushion. The term “A-surface” when referring to a seat cushion refers to the surface of the foam seat cushion with which the occupant will be in the closest contact. The term “B-surface” when referring to a seat cushion refers to the surface of the foam seat cushion in contact with or closest to a support or suspension system. In a refinement, the “B-surface” when referring to a seat cushion is the underside of the foam seat element. The term “A-side” when referring to a seat cushion refers to the side of the foam seat cushion with which the occupant will be in the closest contact. The term “B-side” refers to the side of the foam seat cushion in contact with or closest to a support or suspension system. Similarly, the terms “A-surface” and “A-side” when referring to a trim cover refer to the surface or side of the cover that is viewable when installed in a seat, while the terms “B-surface” and “B-side” when referring to a trim cover refers to the opposite surface or side typically unviewable surface.

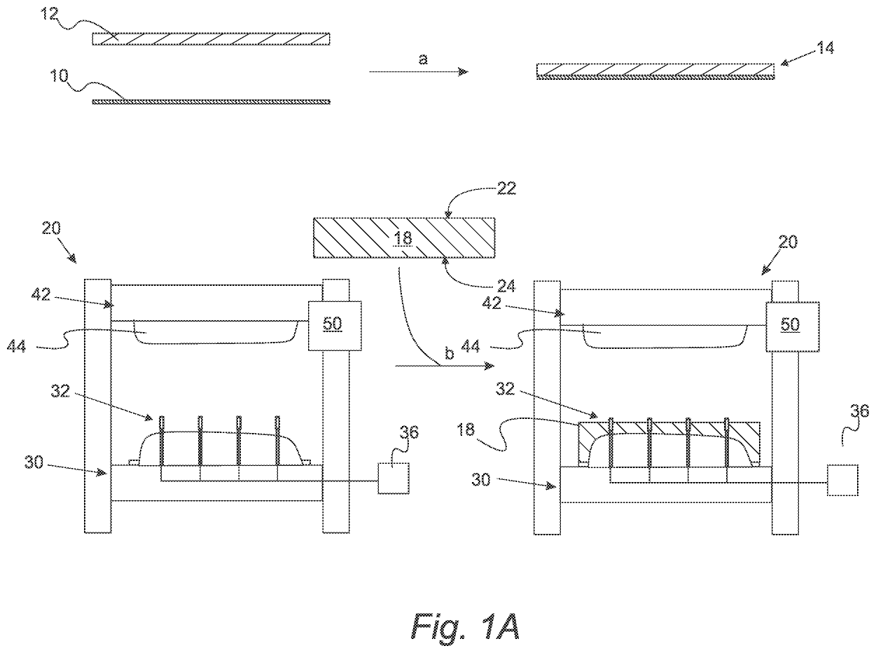

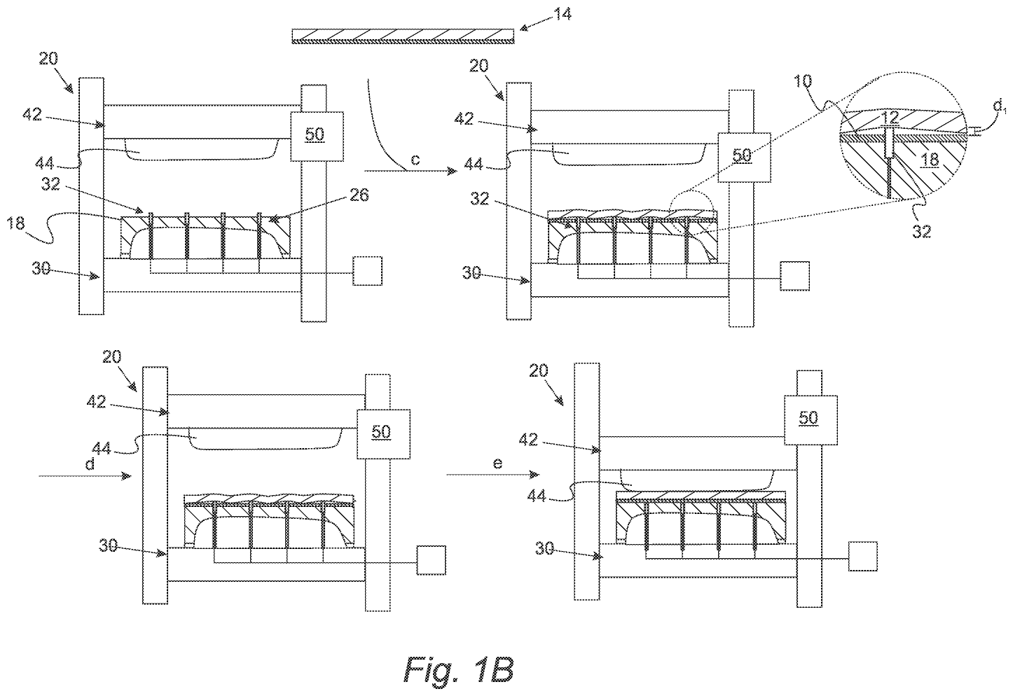

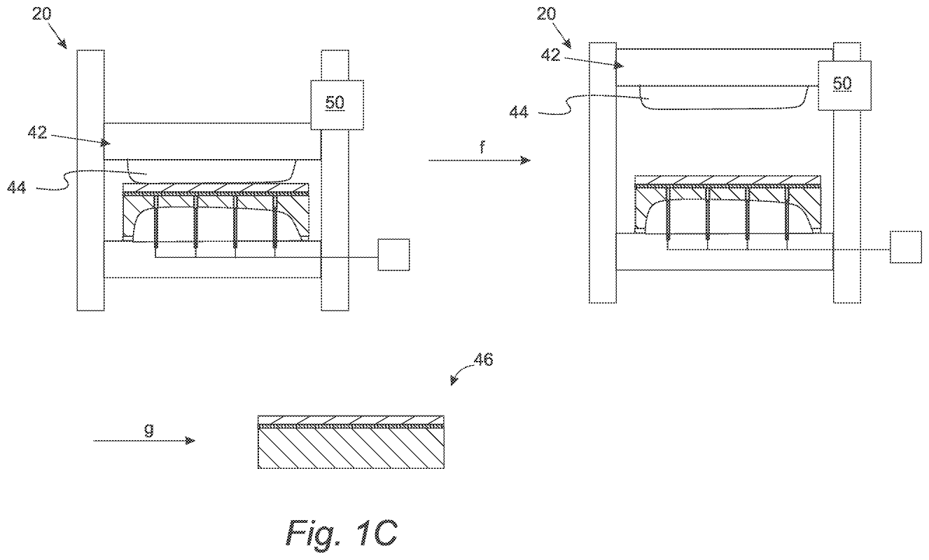

Referring to FIGS. 1A, 1B, 1C, 2, and 3, a method for attaching trim to a seat cushion is schematically illustrated. In step a), an adhesive web 10 is attached to a vehicle seat trim cover 12 to form an adhesive-trim cover combination 14. In step b), foam cushion 18 is placed in a trim-attachment apparatus 20. Foam cushion 18 can be composed of polyurethane. The foam cushion 18 has an A-side with an A-side surface 22 and a B-side with a B-side surface 24. The trim-attachment apparatus 20 includes a heating section 30 having a plurality of hollow injection needles 32. Trim-attachment apparatus 20 also includes a pressing section 42 that includes a pressing element 44. Each hollow injection needle 32 defines at least one outlet opening 34 proximate to a needle tip. The foam cushion 18 is placed on the heating section 30 such that the injection needles 32 extend from the B-side of the foam cushion to the A-side of the foam cushion 18 with the outlet opening 34 protruding a predetermined distance di from the A-side. In a refinement, the predetermined distance di is from 5 to 10 mm.

In a refinement, the adhesive web is composed of a hot melt glue. In a further refinement, the adhesive web is composed of a component selected from the group consisting of thermoplastic polyolefins, polyamides, polyesters, and copolymers thereof. In a further refinement, the adhesive web is composed of a thermoplastic polyolefin. In a further refinement, the adhesive web is composed of a component selected from the group consisting of polyamides, polyesters, and copolymers thereof.

Still referring to FIGS. 1A, 1B, 1C, 2, and 3, in step c), adhesive-trim cover combination 14 is placed over the foam cushion 18. In step d), adhesive web 10 is heated by flowing steam or hot air through the hollow injection needles 32 and the at least one outlet opening 34 at a sufficient temperature to melt the adhesive web. In a refinement, the sufficient temperature to melt the adhesive web is from about 90 to 200° C. In some refinements, the sufficient temperature to melt the adhesive web is at least 80° C., 90° C., 100° C., 110° C., or 120° C. and at most 200° C., 190° C., 180° C., 170° C., 160° C., or 150° C. Typically, the steam or hot air is provided from heated gas source 36, which flows through conduits 38 and then through hollow needles 32 and out of openings 34.

In step e), adhesive-trim cover combination 14 is pressed onto the foam cushion with pressing section 42 from the A-side of the adhesive-trim cover combination. In a refinement, the adhesive-trim cover combination is pressed such that the A-side surface of the seat cushion is depressed by 5 to 10 mm. During this step, hollow injection needles 32 will be retracted prior to or during the step of pressing the adhesive-trim cover combination to avoid puncturing the cover.

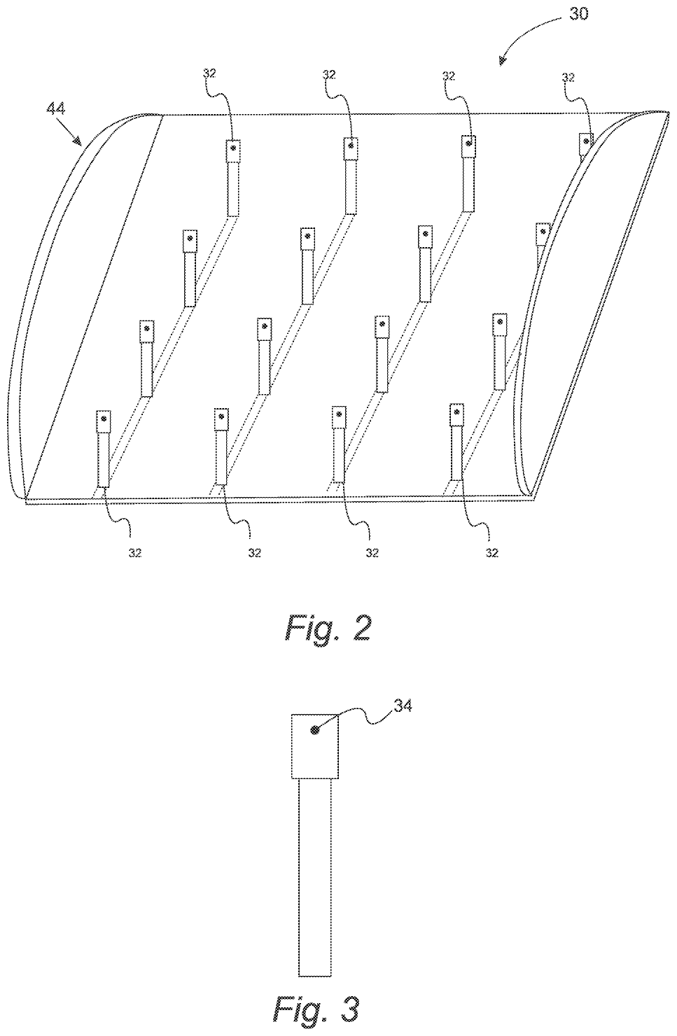

In step f), pressing section 42 is moved away from the trim cover so that in step g), cushion 18 with the attached adhesive-trim cover combination 14 can be removed. As depicted in FIG. 2, the plurality of hollow injection needles 32 are arranged in a predetermined pattern configured to distribute air or steam to melt the adhesive web. In refinement, each hollow needle includes 1 to 4 openings proximate to the needle tip. Typically, each hollow injection needle 32 directs the air or steam in a direction along a face of the adhesive web. In step g), trim-covered seat cushion 46 is removed.

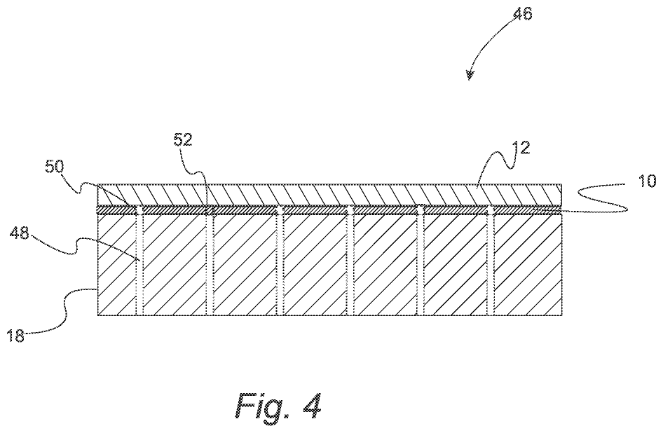

In another embodiment, a trim-covered seat cushion formed by the methods described above is provided. Referring to FIG. 4, a schematic of a trim-covered cushion is provided. Trim-covered seat cushion includes foam cushion 18 having an A-side with an A-side surface and a B-side with a B-side surface as described above. Advantageously, the A-side surface can be concave. Foam cushion 18 includes a first plurality of holes 48 from the A-side surface to the B-side surface. The first plurality of holes 48 is formed from the hollow needles which are used during fabrication. Adhesive web 10 also includes a plurality of blemishes caused by the hollow needles. The blemishes can be identified as having an ordered pattern that correspond to the locations of the hollow needles when passed through the foam cushion. For example, adhesive web 10 can include a second plurality of holes 50 and/or a plurality of dimples 52. Vehicle seat trim cover 12 is attached to the foam cover by the adhesive web. In a refinement, the adhesive web has a thickness from about 0.1 mm to 1 mm.

In at least one aspect, the foam cushion 18 is composed of polyurethane. As set forth above, the adhesive web is composed of a hot melt glue. The adhesive web is composed of a component selected from the group consisting of thermoplastic polyolefins, polyamides, polyesters, and copolymers thereof.

In another aspect, the first plurality of holes 48 are distributed across the foam cushion. In a refinement, holes in the first plurality of holes 48 are separated by about 3 to 8 inches.

In another aspect, the plurality of blemishes aligns to the first plurality of holes 48. In particular, the second plurality of holes 50 aligns to the first plurality of holes 48. In a refinement, the plurality of dimples 52 aligns to the first plurality of holes . In another refinement, the second plurality of holes 50 and the plurality of dimples 52 are intermixed.

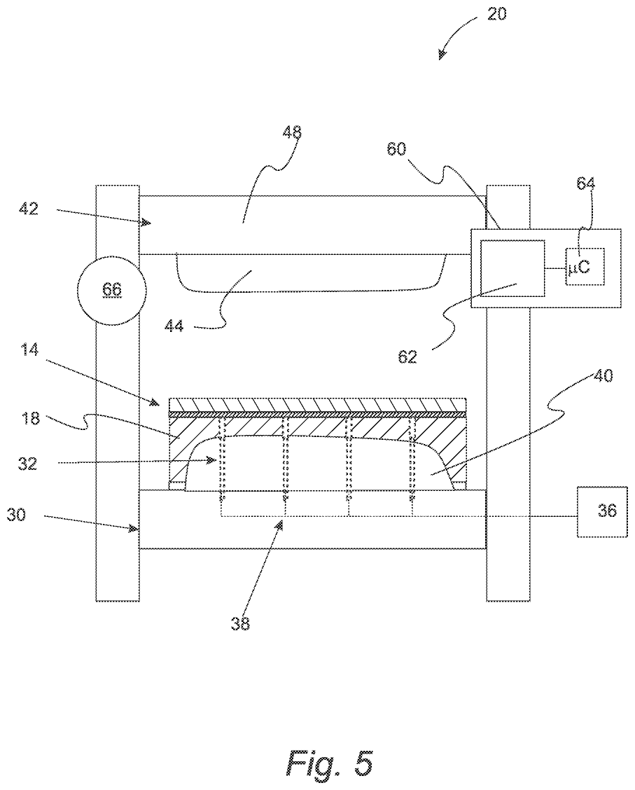

In another embodiment, an apparatus for attaching a trim cover to a seat cushion is provided. Referring to FIG. 5, trim-attachment apparatus 20 includes heating section 30. Heating section 30 includes receptacle 40 for receiving a foam cushion 18 that is covered with an adhesive-trim cover combination 14. The foam cushion 18 has an A-side with an A-side surface and a B-side with a B-side surface. Adhesive-trim cover combination 14 includes a trim layer 12 and an adhesive web 10 aligned to the trim layer. The adhesive web 10 is interposed between the trim layer and the foam cushion. Heating section 30 also includes a plurality of hollow injection needles 32. Each hollow injection needle defines at least one outlet opening 34 proximate to a needle tip. The foam cushion 18 is placed on the heating section such that the hollow injection needles extend from the B-side of the foam cushion to the A-side of the foam cushion with the outlet opening protruding a predetermined distance d₁ from the A-side. In a refinement, the predetermined distance d₁ is from 5 to 10 mm.

Still referring to FIG. 5, pressing section 42 includes a press component 48, the pressing component moveable along guide rails such that the pressing component is configured to move toward the foam cushion to press the adhesive-trim cover combination onto the foam cushion after the adhesive web has been heated by steam or hot air flowing from the plurality of hollow injection needles onto the adhesive web at a sufficient temperature to melt the adhesive web. Trim-attachment apparatus 20 includes heated gas source 36 and conduits 38. The heated air or steam flow from heated source 36 through conduits 38 and then through hollow needles 32 and out of openings 34. The sufficient temperature for melting the adhesive web is as provided above. For example, the sufficient temperature to melt the adhesive web can be from about 90 to 200° C. Control system 60 is configured to control a motor that moves the pressing section towards and away from the heating section. To accomplish these functions, control system 60 can include a display 62 and a microprocessor 64 in electrical communication with the display. In a refinement, control system 60 is configured to move the pressing section 42 towards heating section 30. In a further refinement, control system 60 is configured to move the pressing section 42 towards heating section 30 such that the A-side surface of the seat cushion is depressed by 5 to 10 mm by pressing element 44. In this regard, control system 60 is in electrical communication with a motor 66. In a variation, control system 60 is configured to retract the plurality of hollow injection needles 32 prior to or during the step of pressing the adhesive-trim cover combination. In a variation as described above, the plurality of hollow injection needles are arranged in a predetermined pattern as depicted in FIG. 2. The pattern is configured to distribute hot air or steam to melt the adhesive web. Additional details of the hollow needles, the cover trim and the foam cushion as the same as those set forth above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for attaching trim to a seat cushion, the method comprising:
attaching an adhesive web to a vehicle seat trim cover, the attachment of the adhesive web and the vehicle seat trim cover comprising an adhesive-trim cover combination;
placing a foam cushion in a trim-attachment apparatus, the foam cushion comprising an A-side with an A-side surface and a B-side with a B-side surface, the trim-attachment apparatus comprising a heating section having a plurality of hollow injection needles and a pressing section, each hollow injection needle defining at least one outlet opening proximate to a needle tip, the foam cushion being placed on the heating section such that the hollow injection needles extend from the B-side of the foam cushion to the A-side of the foam cushion with the outlet opening protruding a predetermined distance from the A-side,
placing the adhesive-trim cover combination over the foam cushion;
heating the adhesive web by flowing steam or hot air through the hollow injection needles and the at least one outlet opening at a sufficient temperature to melt the adhesive web; and
pressing the adhesive-trim cover combination onto the foam cushion with the pressing section from the A-side of the adhesive-trim cover combination.

2. The method of claim 1, wherein the sufficient temperature to melt the adhesive web is from about 90 to 200° C.

3. The method of claim 1, wherein the adhesive-trim cover combination is pressed such that the A-side surface of the seat cushion is depressed by 5 to 10 mm.

4. The method of claim 1, wherein the plurality of hollow injection needles are retracted prior to or during the step of pressing the adhesive-trim cover combination.

5. The method of claim 1, wherein the plurality of hollow injection needles are arranged in a predetermined pattern configured to distribute air or steam to melt the adhesive web.

6. The method of claim 1, wherein the adhesive web is composed of a hot melt glue.

7. The method of claim 1, wherein the adhesive web is composed of a component selected from the group consisting of thermoplastic polyolefins, polyamides, polyesters, and copolymers thereof.

8. The method of claim 1, wherein each hollow needle includes 1 to 4 openings proximate to the needle tip.

9. The method of claim 8, wherein each hollow injection needle directs in a direction along a face of the adhesive web.

10. A trim-covered seat cushion comprising:
a foam cushion comprising an A-side with an A-side surface and a B-side with a B-side surface, the foam cushion comprising a first plurality of holes from the A-side surface to the B-side surface;
an adhesive web comprising a second plurality of holes or a plurality of dimples; and
a vehicle seat trim cover attached to the foam cushion by the adhesive web.

11. The trim-covered seat cushion of claim 10, wherein the foam cushion is composed of polyurethane.

12. The trim-covered seat cushion of claim 10, wherein the adhesive web is composed of a hot melt glue.

13. The trim-covered seat cushion of claim 10, wherein the adhesive web is composed of a component selected from the group consisting of thermoplastic polyolefins, polyamides, polyesters, and copolymers thereof.

14. The trim-covered seat cushion of claim 10, wherein the first plurality of holes are distributed across the foam cushion.

15. The trim-covered seat cushion of claim 14, wherein holes in the first plurality of holes are separated by about 3 to 8 inches.

16. The trim-covered seat cushion of claim 10, wherein the second plurality of holes aligns to the first plurality of holes.

17. The trim-covered seat cushion of claim 10, wherein the plurality of dimples aligns to the first plurality of holes.

18. The trim-covered seat cushion of claim 10, wherein the second plurality of holes and the plurality of dimples are intermixed.

19. The trim-covered seat cushion of claim 10, wherein the A-side surface is concave.

20. The trim-covered seat cushion of claim 10, wherein the adhesive web has a thickness from about 0.1 mm to 1 mm.
